(19) United States
(12) Patent Application Publication
(10) Pub. No.: US 2019/0183256 A1
(43) Pub. Date: Jun. 20, 2019

(54) PEINDIVIDUALLY-CONTOURED SEAT CUSHION, SHAPE CAPTURING, AND FABRICATING METHOD AND SYSTEM FOR SEAT CUSHION

(71) Applicants: Ashish Upadhyay, Irvine, CA (US); Dhwani Upadhyay, Irvine, CA (US)

(72) Inventors: Ashish Upadhyay, Irvine, CA (US); Dhwani Upadhyay, Irvine, CA (US)

(21) Appl. No.: 16/221,580

(22) Filed: Dec. 16, 2018

Related U.S. Application Data
(60) Provisional application No. 62/599,892, filed on Dec. 18, 2017.

(51) Int. Cl. A47C 31/12; G06T 17/10; G06F 17/50

(52) U.S. Cl. CPC A47C 31/126; G06F 17/5095; G06F 17/5086; G06T 17/10

(57) ABSTRACT

The present invention discloses a method and a system of computer-assisted assessment of seat cushion design. The method includes capturing a first set of data and a second set of data from a surface of a seat cushion through a sensor module. Further, the method includes designing a three-dimensional seat cushion for the user based on the first set of data and the second set of data. The first set of data includes heat graphs related to seating posture of the user and position of tailbone of the user in the seating posture. Further, the second set of data includes body weight of the user in the seating position.

### CROSS-REFERENCE TO RELATED PATENT DOCUMENTS

This patent application claims the benefit of priority of U.S. Provisional Application No. 62/599,892, entitled “INDIVIDUALLY-CONTOURED SEAT CUSHION, SHAPE CAPTURING AND FABRICATING METHOD FOR SEAT CUSHION,” filed Dec. 18, 2017, which are hereby incorporated herein by reference in its entirety.

### FIELD OF THE INVENTION

The present invention relates generally to seat cushions, and, more particularly, to individually-contoured seat cushion, shape capturing, and fabricating method and system for seat cushion by measuring and recording an impression of a person's seat contact contour with respect to at least one of tailbone, seating posture, body weight, buttocks and thighs as well as dorsal and lateral trunk surfaces, for designing and fabricating a customized seat cushion.

### BACKGROUND

The art of seating has grown to a science involving considerations of physiology, material science, and ergonomics. Seat cushions have a critical role in the modem society. This is especially true for those users who spend a large amount of time on the seat cushions. A seat cushion is a soft furry bag of some ornamental material, stuffed with wool, hair, feathers, polyester staple fiber, non-woven material, or even paper torn into fragments. The seat cushion is designed to perform a number of important functions. For example, the seat cushion is used for sitting or kneeling upon, or to soften the hardness or angularity of a chair or couch. The seat cushion should be comfortable and capable of providing proper support for optimal posture and posture control for a considerable length of time. The seat cushion should also permit a useful range of motion from the pelvis and upper torso of the person. Most importantly, the seat cushion should help prevent and reduce the incidence of pressure ulcers created by prolonged sitting on the cushion without adequate pressure relief. Pressure ulcers can become a very serious health problem for individuals who remain constantly in contact with the support cushion, and it is important to avoid such pressure ulcers. In order to avoid the pressure ulcers, it is necessary to calculate how much pressure and pressure gradients are experienced by different parts of the body while sitting on the seat cushion.

A simple pressure map of a seating surface typically provides insufficient information to visualize and standardize the assessment of the impact of pressures on the human body. A more advanced approach is to divide the automotive seating, for example, seat and backrest, into different zones and calculate pressure or other physical measurements for each zone. These zones may be mapped onto a human body model in order to assess the impact of sitting pressures, and other metrics, on the body.

In order to accurately map pressure and other physical measurements onto the human body model, the pressure measurements and seating zones should be aligned to the human body model. However, manually separating the pressure map data into the seating zones and mapping those against the human body model is a lengthy process that is prone to error.

Further, different people have different body weight, shape, and size. So, a seat cushion that is comfortable for one person may not be comfortable for another one. Hence, to provide a comfortable siting posture to a person, there is a need of a system and a method for measuring and recording an impression of a person's seat contact contour for designing and fabricating a custom contoured seat cushion for the person.

While the present invention encompasses multiple aspects, overall goals include maintenance of good health, and comfort of the person. Further, the seat cushion should be reliable and durable. The seat cushion should be easy to clean and maintain. Finally, the seat cushion should be safe for the person who is using it.

### SUMMARY

It will be understood that this disclosure is not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

It is an objective of the present invention to provide a system and a method for measuring, recording, storing, and processing an impression of a user's seat contact contour, i.e., buttocks and thighs as well as dorsal and lateral trunk surfaces, for designing and fabricating a customized seat cushion for the user.

It is another objective of the present invention to provide a system and a method for measuring and recording tactile sensor data for the user by means of one or more tactile sensors that have been included in a test pad (e.g., a seat including a seat cushion), when the user sits on the test pad. In an embodiment, the tactile sensor data includes information (related to texture, shape, hardness, thickness, elasticity, position, angles, temperature, or the like) arising from physical interaction of the user with the test pad i.e., when the user sits on the test pad including the one or more tactile sensors. In an embodiment, the one or more tactile sensors process the tactile sensor data to plot one or more heat graphs related to at least a seating posture of the user on the test pad and a position of tailbone (i.e., coccyx) of the user in the seating posture.

It is another objective of the present invention to provide a system and a method for measuring and recording seating weight data (i.e., the body weight) of the user by means of the one or more tactile sensors or weight sensors that have been included in a test pad, when the user sits on the test pad. The system and the method of the present invention considers the body weight of the user while designing the custom contoured seat cushion.

It is another objective of the present invention to provide a computer-assisted assessment of a seat cushion design for the user based on at least the tactile sensor data and the weight data of the user.

In an embodiment, the present invention discloses a system and a method of computer-assisted assessment of the seat cushion design. The method includes capturing a first set of data and a second set of data from a sensor module including the one or more tactile sensors and/or weight sensors that have been included in the test pad. In an embodiment, the first set of data includes the one or more heat graphs related to the seating posture of the user on the test pad and the position of the tailbone of the user in the seating posture. In an embodiment, the second set of data includes the seating weight data of the user in the seating posture on the test pad.

Further, in an embodiment, the method includes processing the first set of data and the second set of data to design a three-dimensional customized seat cushion for the user. In an embodiment, the three-dimensional customized seat cushion may be designed or plotted that is specific to the user's tailbone position, seating posture, and resiliency specific to the user's seating weight.

The foregoing has outlined rather broadly the features and technical advantages of the present invention in order that the detailed description of the invention that follows may be better understood. These and other features and advantages along with other embodiments of the present invention will become apparent from the detailed description below, in light of the accompanying drawings.

### BRIEF DESCRIPTION OF THE DRAWINGS

The novel features which are believed to be characteristic of the present disclosure, as to its structure, organization, use, and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this disclosure will now be described by way of example in association with the accompanying drawings in which:

FIG. 1 illustrates a system for measuring, recording, and processing an impression of a user's seat contact contour for designing and fabricating a custom contoured seat cushion, according to an exemplary embodiment of the present invention;

FIG. 2 is a flowchart illustrating a method of computer-assisted assessment of a seat cushion design, according to an exemplary embodiment of the invention;

FIG. 3 illustrates a block diagram of a seat cushion designing platform, according to an exemplary embodiment of the invention; and

FIG. 4 is a block diagram that illustrates a computer system for designing and fabricating a custom contoured seat cushion for a user, according to an exemplary embodiment of the invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the Figures are illustrated for simplicity and clarity and are not necessarily drawn to scale. For example, the dimensions of some of the elements in the Figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of components, which constitutes a system for measuring, recording, and processing an impression of a user's seat contact contour for designing and fabricating a custom contoured seat cushion. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items.

Techniques consistent with the present invention provide, among other features, a method and a system for designing and fabricating a custom contoured seat cushion for a user based on sensor data that has been measured and recorded by one or more sensors (such as one or more tactile and/or weight sensors) included in a seat, when the user sits on the seat. Unless stated otherwise, terms such as “first” and “second” are used to arbitrarily distinguish between the elements such terms describe. Thus, these terms are not necessarily intended to indicate temporal or other prioritization of such elements. While various exemplary embodiments of the disclosed system and method have been described below, it should be understood that they have been presented for purposes of example only, and not limitations. It is not exhaustive and does not limit the invention to the precise form disclosed. Modifications and variations are possible in light of the above teachings or may be acquired from practicing of the invention, without departing from the breadth or scope of the present invention.

The method and the system for designing and fabricating a custom contoured seat cushion will now be described with reference to the accompanying drawings which should be regarded as merely illustrative without restricting the scope and ambit of the disclosure.

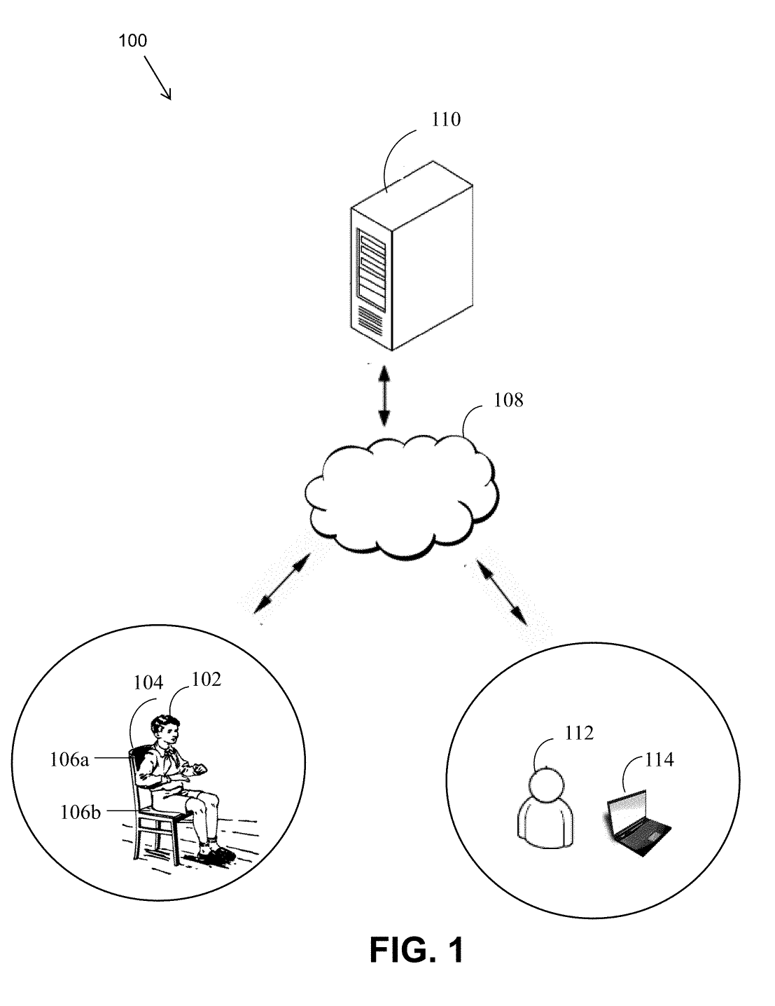

Referring now to FIG. 1, a system 100 for measuring, recording, and processing an impression of a user's seat contact contour for designing and fabricating a custom contoured seat cushion is shown, according to an exemplary embodiment of the present invention.

The environment of FIG. 1 shows the system 100 including a user 102, a seat 104 having a seat back 106a and a seat bottom 106b, a seat cushion designing platform 110, an admin 112, and a communication device 114. The seat 104, the seat cushion designing platform 110, and a communication device 114 are communicatively connected to each other over a network 108.

The seat 104 is a place to sit. For example, the user 102 is sitting on the seat 104, as shown in FIG. 1. Examples of the seat 104 include, but are not limited to, a vehicle seat, a wheel chair seat, a bicycle seat, a sofa seat, and the like. The vehicle seat may be suitable for use in any number of environments, including but not limited to automobiles, watercrafts, aircrafts, boating, child seats, military applications, heavy trucks, and the like. The wheel chair seat may be suitable for use with a wheel chair that is used when walking is difficult or impossible due to illness, injury, or disability. The bicycle seat may be suitable for use with a bicycle and may be designed to support the rider's buttocks and/or back. The sofa seat may be suitable for use with a sofa that is a piece of furniture found in the family room, living room, den, or the lounge and facilitates sitting of one or more people.

The seat 104 may include any number of components, such as, but are not limited to, the seat back 106a and the seat bottom 106b. The seat back 106a and the seat bottom 106b may include any number of elements for supporting an occupant such as the user 102. The seat back 106a and the seat bottom 106b may include other features associated with the seat 104, such as, but are not limited to, a frame, suspension, foam support, lumbar, and the like. Both the seat back 106a and the seat bottom 106b include a number of seat elements, such as, but are not limited to, a frame, cushion, lumbar system, recliner pivot, and weight bearing surfaces. The seat elements may exert a force against the occupant thereof. The amount of force may depend on any number of variables associated with the seat elements comprising the component, such as, but are not limited to, their size, shape, feel, positioning, and other controllable aspects. The configuration of the elements may be selected to influence an opinion of the user 102 with respect to comfort, performance, and other amenities associated with seating quality.

Different manufacturers or manufacturers having different product lines may produce seat components (e.g., seat cushion) with varying levels of comfort, quality, user satisfaction, etc., depending on the particular elements comprising the components. As such, any number of variables may influence the occupant perceived seating quality. One indicator of such seat quality is relative pressure between the occupant (i.e., the user 102) and seat component (e.g., seat cushion). Pressure points experienced between the seat components and elements with respect to the occupant can greatly influence the occupant's satisfaction with the seat 104. Pressure at certain locations of the occupant's body may be less desirable than at other locations. Occupants of varying size, shape, and weight may perceive such pressures differently. The design, positioning, dimensioning, material composition, and other controllable features of the component elements can dictate the location and severity of the pressure points. The location and severity of the pressure points may vary from manufacture to manufacture and/or across product lines of the same manufacture, depending on the specifications used to construct the component elements.

In order to accurately obtain pressure data from pressure points and map pressure and other physical measurements onto the human body model to provide a custom contoured seat cushion, the seat 104 may include a sensor module (not shown), may be in the form of pad or the like. The sensor module includes one or more sensors (such as one or more tactile sensors and/or weight sensors). The one or more sensors are at predetermined locations and in a predetermined pattern configured to provide output signals related to predetermined posture modes of the user 102 applying pressure or force to the seat component of the seat 104. In another embodiment, the one or more sensors are dynamically located in the seat 104 and in a dynamic pattern based on at least one of the shape, size, and gender of the user 102 and are configured to provide output signals related to predetermined posture modes of the user 102 applying pressure or force to the seat component of the seat 104. The one or more sensors are configured to generate the output signals based on the measure and record of sensor data when the user 102 sits on the seat 104 and generate one or more heat graphs related to seating posture of the user 102 (i.e., the occupant) and position of tailbone/coccyx of the user 102 in the seating posture. A heat graph is a graphical representation of the sensor data where the individual values contained in a matrix are represented as colors. Examples of the one or more sensors include, but are not limited to, a tactile sensor, a pressure sensor, a weight sensor, a physiological sensor, and the like. Further, the one or more sensors are configured to obtain body weight of the user 102 in seating position.

In this application, the one or more sensors are in “circuit communication” with the seat cushion designing platform 110 by which the one or more sensors may transmit sensor data (such as position data, seating posture data, weight data, or the like) to the seat cushion designing platform 110, via the network 108. Furthermore, the one or more sensors may be located in the seat 104 to produce output related to one or more “posture modes” i.e., the one or more sensors are selectively located in relation to a seat component such that they respond to pressure or force at their selective locations in a manner such that their output can be related to one of a number of predetermined posture positions, as opposed to a large number of sensors disposed over an entire surface to enable the one or more sensors to produce a complete pressure map of a body applying pressure or force to the surface. Additionally, the sensor module connected with the seat cushion means that the one or more sensors can be directly connected to the seat cushion, or indirectly connected to the seat cushion through an intermediate member. It should also be noted that a “pressure pad” is an area sensor (which can be formed, for example, using pressure sensitive ink) that is capable of measuring the average force over the area of the sensor and this can be done directly via pressure, or indirectly via force or displacement.

Further, in an embodiment, after measuring and recording the sensor data by the sensor module when the user 102 sits on the seat 104, the sensor module may be configured to transmit the sensor data to the seat cushion designing platform 110 via the network 108. In an embodiment, the network 108 may include suitable logic, circuitry, interfaces, and/or code, executable by the circuitry, that may be configured to transmit queries, messages, content, data, and requests between various entities of the system 100. In an embodiment, the network 108 includes a wired network. In another embodiment, the network 108 includes a wireless network. Examples of types of the network 108 include, but are not limited to, a local area network, a wide area network, a radio network, a virtual private network, an internet area network, a metropolitan area network, a satellite network, a wireless fidelity (Wi-Fi) network, a light fidelity (Li-Fi) network, Bluetooth Low energy, a wireless network, and a telecommunication network. Examples of the telecommunication network include, but are not be limited to, a global system for mobile communication (GSM) network, a general packet radio service (GPRS) network, third Generation Partnership Project (3GPP), an enhanced data GSM environment (EDGE), and a Universal Mobile Telecommunications System (UMTS). The present invention should not be limited in its communication nomenclature.

In an embodiment, the seat cushion designing platform 110 may include suitable logic, circuitry, interfaces, and/or code, executable by the circuitry, that may be configured to perform one or more operations for designing and fabricating the custom contoured seat cushion for the user 102. The seat cushion designing platform 110 may be a computing device, which may include a software framework, that may be configured to create an application server implementation and perform the various operations such as processing of the sensor data for designing and fabricating the custom contoured seat cushion for the user 102, as disclosed in the present invention. The seat cushion designing platform 110 may be realized through various web-based technologies, such as, but not limited to, a Java web-framework, a .NET framework, a PHP framework, a python framework, or any other web-application framework. Examples of the seat cushion designing platform 110 include, but are not limited to, a personal computer, a laptop, or a network of computer systems. In an embodiment, the seat cushion designing platform 110 is an application that is installed on the communication device 114. In another embodiment, the seat cushion designing platform 110 is a browser application. In yet another embodiment, the seat cushion designing platform 110 is a client-side application that is embedded on backend of a client portal.

In an embodiment, the seat cushion designing platform 110 may include software modules and hardware module to design and fabricate the custom contoured seat cushion. The seat cushion designing platform 110 receives heat graph related to the seating posture of the user 102 (i.e., the occupant) and the position of tailbone of the user 102 in the seating posture, and weight of the user 102 in the seating position from the sensor module. Based on the received data, the seat cushion designing platform 110 designs and fabricates a three-dimensional seat cushion that is specific to the user 102.

In an embodiment, the admin 112 can access the seat cushion designing platform 110 though the communication device 114. In context of the present invention, the admin 112 is a person who can design/plot the three-dimensional seat cushion that is specific to the user 102 using design tools. Examples of design tools include, but are not limited to, computer-aided design (CAD) tool, computer-aided design and drafting (CADD) tool, mechanical design automation (MDA) tool, Computer-aided manufacturing (CAM) tool, and the like. In context of the present invention, the communication device 114 refers to an electronic device (e.g., a computing device) that can be used to communicate over the network 108. Examples of the communication device 114 include, but are not limited to, a cell phone, a smart phone, a cellular phone, a cellular mobile phone, a personal digital assistant (PDA), a wireless communication terminal, a laptop, a personal computer, and a tablet computer.

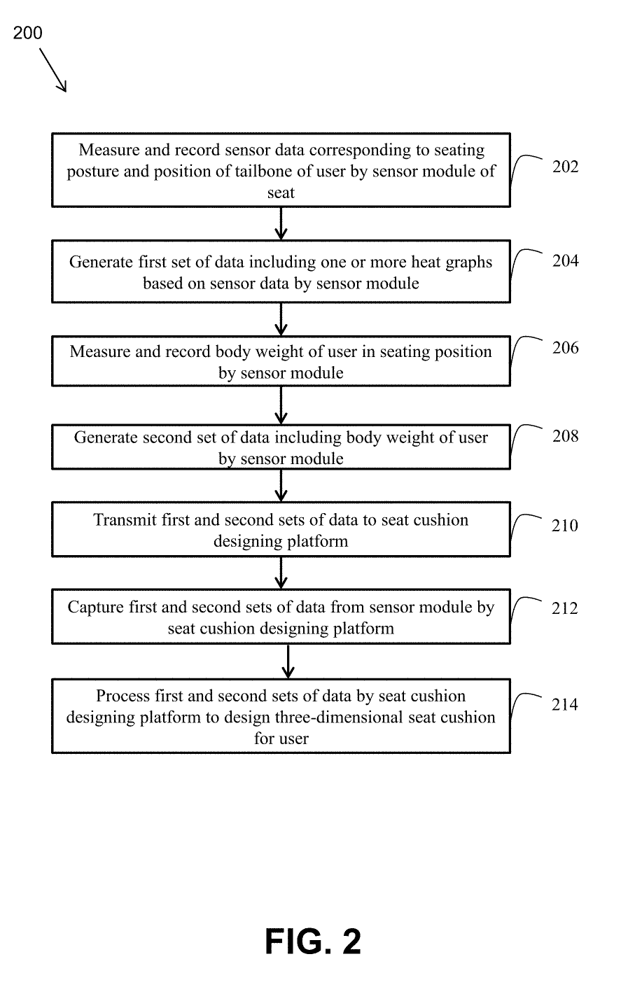

FIG. 2 is a flowchart 200 illustrating a method of computer-assisted assessment of seat cushion design, according to an exemplary embodiment of the invention.

At step 202, the method includes measuring and recording the sensor data corresponding to the seating posture and position of tailbone of the user 102. The sensor module of the seat 104 may be configured to measure and record the sensor data corresponding to the seating posture and position of tailbone of the user 102, when the user 102 sits on the seat 104. The sensor module includes the one or more sensors, such as, but are not limited to, one or more tactile sensors, pressure sensors, weight sensors, and physiological sensors.

At step 204, the method includes generating a first set of data including one or more heat graphs. The one or more heat graphs are generated based on the sensor data corresponding to the seating posture and position of tailbone of the user 102. The sensor module of the seat 104 may be configured to generate the first set of data including one or more heat graphs.

At step 206, the method includes measuring and recording the body weight of the user 102 in the seating position of the user 102 on the seat 104. The sensor module of the seat 104 may be configured to measure and record the body weight of the user 102 in the seating position.

At step 208, the method includes generating a second set of data including the body weight of the user 102. The sensor module of the seat 104 may be configured to generate the second set of data including the body weight of the user 102.

At step 210, the method includes transmitting the first set of data and the second set of data to the seat cushion designing platform 110. In an embodiment, the sensor module of the seat 104 may be configured to transmit the first set of data and the second set of data to the seat cushion designing platform 110 via the network 108. In another embodiment, the seat 104 may include a separate transceiver device (not shown) that is configured to obtain the first set of data and the second set of data from the sensor module of the seat 104 and transmit the first set of data and the second set of data to the seat cushion designing platform 110 via the network 108. The first set of data includes the one or more heat graphs related to the seating posture and position of tailbone of the user 102. The second set of data includes the body weight of the user 102 in the seating position.

At step 212, the method includes capturing the first set of data and the second set of data from the sensor module or the separate transceiver device of the seat 104. The seat cushion designing platform 110 may be configured to receive or capture the first set of data and the second set of data from the sensor module or the separate transceiver device of the seat 104. The method allows the seat cushion designing platform 110 to capture the first set of data and the second set of data from the sensor module or the separate transceiver device of the seat 104 via the network 108.

At step 214, the method includes processing the first set of data and the second set of data to design a three-dimensional seat cushion for the user 102. The seat cushion designing platform 110 may be configured to process the first set of data and the second set of data to design the three-dimensional seat cushion. The method allows the seat cushion designing platform 110 to design the three-dimensional seat cushion based on the first set of data and the second set of data (i.e., the one or more heat graphs related to the seating posture and position of tailbone of the user 102 and the body weight of the user 102). The three-dimensional seat cushion is plotted that is specific to the user's tailbone position, seating posture, and resiliency specific to the user's seating weight.

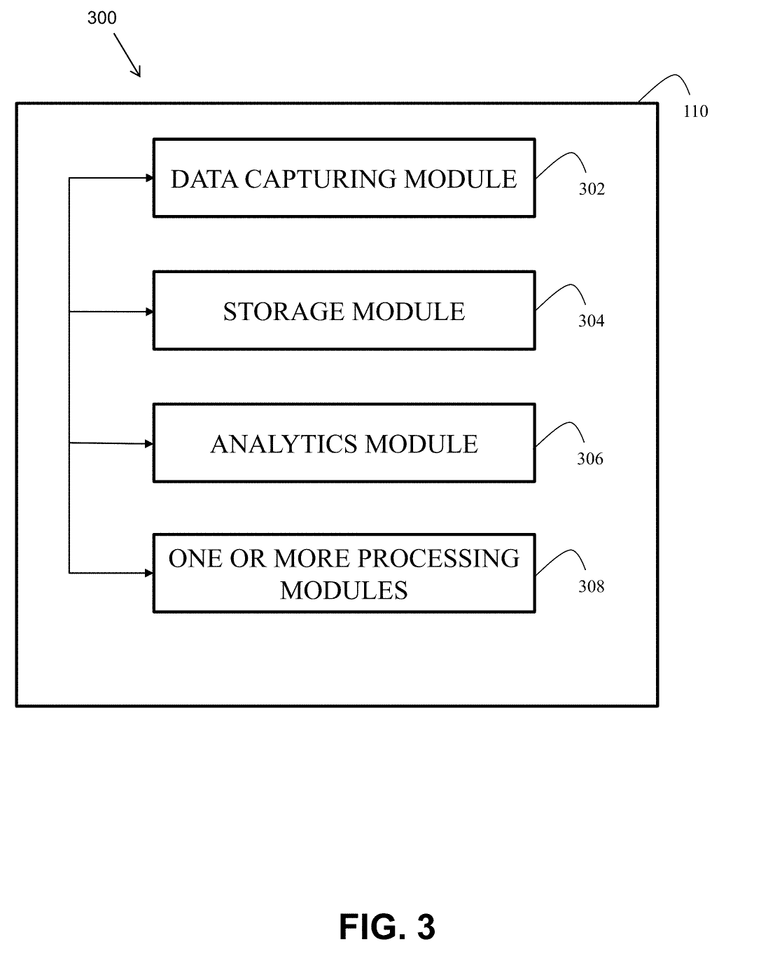

FIG. 3 illustrates a block diagram 300 of the seat cushion designing platform 110, according to an exemplary embodiment of the invention. In an embodiment, the seat cushion designing platform 110 includes a data capturing module 302, a storage module 304, an analytics module 306, and one or more processing modules 308.

The data capturing module 302 may include suitable logic, circuitry, interfaces, and/or codes, executable by the circuitry, that may be configured to perform one or more operations. The data capturing module 302 is configured to capture the one or more heat graphs related to the seating posture of the user 102 (i.e., the occupant) and position of tailbone of the user 102 in the seating posture. Further, the data capturing module 302 captures the body weight of the user 102 in the seating position. Examples of the data capturing module 302 include, but are not limited to, an application-specific integrated circuit (ASIC) processor, a reduced instruction set computing (RISC) processor, a complex instruction set computing (CISC) processor, or a field-programmable gate array (FPGA).

The storage module 304 may include suitable logic, circuitry, interfaces, and/or codes, executable by the circuitry, that may be configured to perform one or more operations. The storage module 304 is configured to store data related to each user (i.e., one or more heat graphs related to the seating posture of each user, position of tailbone of each user in the seating posture, and the body weight of each user in the seating position). In an embodiment, the storage module 304 is a multi-tier storage system. In another embodiment, the storage module 304 stores the information in an encrypted format. In yet another embodiment, the storage module 304 stores the information in an indexed format. The storage module 304 facilitates storage, retrieval, modification, and deletion of data in conjunction with various data-processing operations. Storage module information may be retrieved through queries using keywords and sorting commands, in order to rapidly search, rearrange, group, and select the field.

In one embodiment, the storage module 304 is secure web servers and Hypertext Transport Protocol Secure (HTTPS) capable of supporting Transport Layer Security (TLS. Communications to and from the secure web servers may be secured using Secure Sockets Layer (SSL). An SSL session may be started by sending a request to the Web server with an HTTPS prefix in the URL. Alternatively, any known communication protocols that enable devices within a computer network to exchange information may be used. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol), POP3 (Post Office Protocol 3), SMTP (Simple Mail Transfer Protocol), IMAP (Internet Message Access Protocol), SOAP (Simple Object Access Protocol), PPP (Point-to-Point Protocol), RFB (Remote Frame buffer) Protocol.

The analytics module 306 may include suitable logic, circuitry, interfaces, and/or codes, executable by the circuitry that may be configured to perform one or more operations. The analytics module 306 receives the one or more heat graphs and the body weight of the user 102 from the data capturing module 302. Based on the received data, the seat cushion designing platform 110 designs and fabricates the three-dimensional seat cushion that is specific to the user 102. The analytics module 306 may be implemented by one or more processors, such as, but are not limited to, an ASIC processor, a RISC processor, a CISC processor, and an FPGA.

The one or more processing modules 308 may include suitable logic, circuitry, interfaces, and/or codes, executable by the circuitry, that may be configured to perform one or more operations. The one or more processing modules 308 is configured to process the data related to the user 102. Examples of the one or more processing modules 308 includes, but are not limited to, a central processing unit (CPU), a front-end processor, a microprocessor, a graphics processing unit (GPUNPU), a physics processing unit (PPU), a digital signal processor, and a network processor.

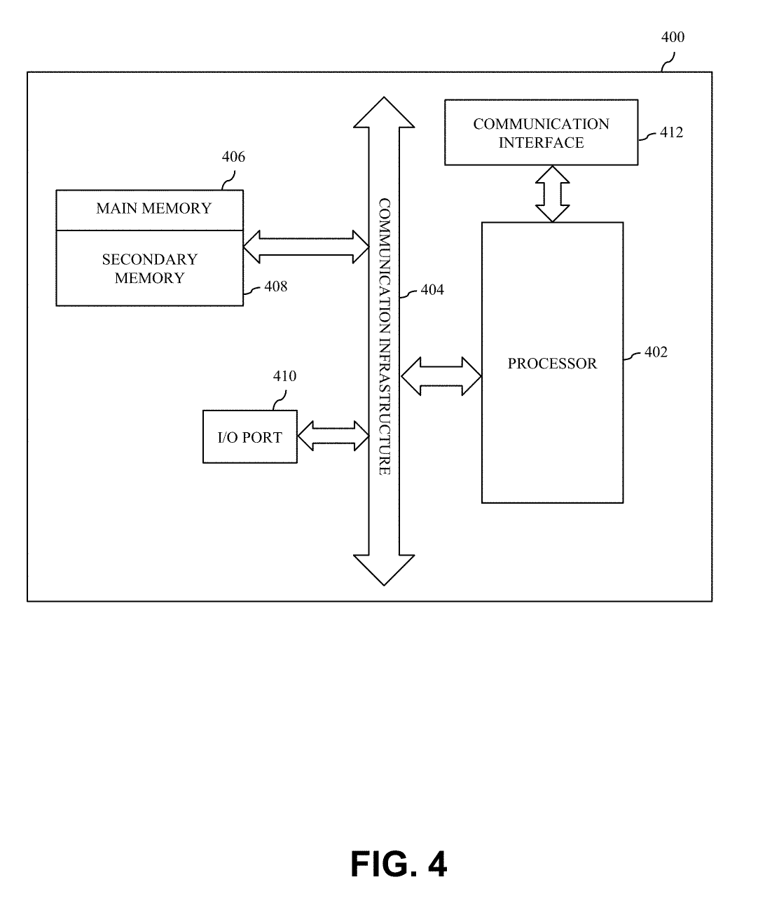

FIG. 4 is a block diagram that illustrates a computer system 400 for designing and fabricating the custom contoured seat cushion for the user 102, according to an exemplary embodiment of the invention.

An embodiment of the present invention, or portions thereof, may be implemented as computer readable code on the computer system 400. In one example, the seat cushion designing platform 110 of FIG. 1 may be implemented in the computer system 300 using hardware, software, firmware, non-transitory computer readable media having instructions stored thereon, or a combination thereof and may be implemented in one or more computer systems or other processing systems. Hardware, software, or any combination thereof may embody modules and components used to implement the method of FIG. 2. The computer system 400 includes a processor 402 that may be a special purpose or a general-purpose processing device. The processor 402 may be a single processor, multiple processors, or combinations thereof. The processor 402 may have one or more processor “cores.” Further, the processor 402 may be connected to a communication infrastructure 404, such as a bus, a bridge, a message queue, the network 108, multi-core message-passing scheme, and the like. The computer system 400 further includes a main memory 406 and a secondary memory 408. Examples of the main memory 406 may include RAM, ROM, and the like. The secondary memory 408 may include a hard disk drive or a removable storage drive (not shown), such as a floppy disk drive, a magnetic tape drive, a compact disk, an optical disk drive, a flash memory, and the like. Further, the removable storage drive may read from and/or write to a removable storage device in a manner known in the art. In an embodiment, the removable storage unit may be a non-transitory computer readable recording media. The computer system 400 further includes an input/output (I/O) port 410 and a communication interface 412. The I/O port 410 includes various input and output devices that are configured to communicate with the processor 402. Examples of the input devices may include a keyboard, a mouse, a joystick, a touchscreen, a microphone, and the like. Examples of the output devices may include a display screen, a speaker, headphones, and the like. The communication interface 412 may be configured to allow data to be transferred between the computer system 400 and various devices that are communicatively coupled to the computer system 400. Examples of the communication interface 412 may include a modem, a network interface, i.e., an Ethernet card, a communications port, and the like. Data transferred via the communication interface 412 may be signals, such as electronic, electromagnetic, optical, or other signals as will be apparent to a person skilled in the art. The signals may travel via a communications channel, such as the network 108, which may be configured to transmit the signals to the various devices that are communicatively coupled to the computer system 400. Examples of the communication channel may include, but not limited to, cable, fiber optics, a phone line, a cellular phone link, a radio frequency link, a wireless link, and the like. Computer program medium and computer usable medium may refer to memories, such as the main memory 406 and the secondary memory 408, which may be a semiconductor memory such as dynamic RAMs. These computer program mediums may provide data that enables the computer system 400 to implement the method illustrated in FIG. 2. In an embodiment, the present invention is implemented using a computer implemented application. The computer implemented application may be stored in a computer program product and loaded into the computer system 400 using the removable storage drive or the hard disk drive in the secondary memory 408, the I/O port 410, or the communication interface 412.

Although particular embodiments of the invention have been described in detail for purposes of illustration, various modifications and enhancements may be made without departing from the spirit and scope of the invention.

It will finally be understood that the disclosed embodiments are presently preferred examples of how to make and use the claimed invention, and are intended to be explanatory rather than limiting of the scope of the invention as defined by the claims below. Reasonable variations and modifications of the illustrated examples in the foregoing written specification and drawings are possible without departing from the scope of the invention as defined in the claim below. It should further be understood that to the extent the term “invention” is used in the written specification, it is not to be construed as a limited term as to number of claimed or disclosed inventions or the scope of any such invention, but as a term which has long been conveniently and widely used to describe new and useful improvements in technology The scope of the invention supported by the above disclosure should accordingly be construed within the scope of what it teaches and suggests to those skilled in the art, and within the scope of any claims that the above disclosure supports.

We claim:

1. A method of computer-assisted assessment of seat cushion design, the method comprising:
capturing, from a sensor module of a seat, a first set of data including one or more heat graphs related to a seating posture of a user and position of tailbone of the user in the seating posture, when the user sits on the seat;
capturing, from the sensor module of the seat, a second set of data, when the user sits on the seat; and
designing a three-dimensional seat cushion for the user based on the first set of data and the second set of data.

2. The method of claim 1, wherein the one or more heat graphs are generated by the sensor module based on sensor data measured and recorded by the sensor module, when the user sits on the seat.

3. The method of claim 2, wherein the sensor data comprises measurement of information corresponding to the seating posture of the user and the position of tailbone of the user in the seating posture.

4. The method of claim 1, wherein the second set of data comprises body weight of the user in the seating position, wherein the body weight is measured and recorded by the sensor module, when the user sits on the seat.

5. The method of claim 1, wherein the sensor module comprises one or more sensors including at least one or more tactile sensors, pressure sensors, weight sensors, and physiological sensors.

6. The method of claim 5, wherein the one or more sensors are at predetermined locations in the seat and in a predetermined pattern.

7. The method of claim 5, wherein the one or more sensors are dynamically located in the seat and in a dynamic pattern based on at least one of a shape and a size of the user.

8. A seat cushion designing platform for designing a seat cushion, the seat cushion designing platform comprising:
circuitry configured to:
capture, from a sensor module of a seat, a first set of data including one or more heat graphs related to a seating posture of a user and position of tailbone of the user in the seating posture, when the user sits on the seat;
capture, from the sensor module of the seat, a second set of data, when the user sits on the seat; and
design a three-dimensional seat cushion for the user based on the first set of data and the second set of data.

9. The seat cushion designing platform of claim 8, wherein the one or more heat graphs are generated by the sensor module based on sensor data measured and recorded by the sensor module, when the user sits on the seat.

10. The seat cushion designing platform of claim 9, wherein the sensor data comprises measurement of information corresponding to the seating posture of the user and the position of tailbone of the user in the seating posture.

11. The seat cushion designing platform of claim 8, wherein the second set of data comprises body weight of the user in the seating position, wherein the body weight is measured and recorded by the sensor module, when the user sits on the seat.

12. The seat cushion designing platform of claim 8, wherein the sensor module comprises one or more sensors including at least one or more tactile sensors, pressure sensors, weight sensors, and physiological sensors.

13. The seat cushion designing platform of claim 12, wherein the one or more sensors are at predetermined locations in the seat and in a predetermined pattern.

14. The seat cushion designing platform of claim 12, wherein the one or more sensors are dynamically located in the seat and in a dynamic pattern based on at least one of a shape and a size of the user.
